(19) United States
(12) Patent Application Publication
(10) Pub. No.: US 2025/0026419 A1
(43) Pub. Date: Jan. 23, 2025

(54) DEFLECTOR ARRANGEMENT FOR A TRACKED VEHICLE

(71) Applicant: BAE Systems Hägglunds Aktiebolag, Örnsköldsvik (SE)

(72) Inventors: Anders BODIN, Örnsköldsvik (SE); Göran WESTMAN, Moliden (SE); Ulf WIBERG, Arnäsvall (SE); Assar CHRISTENSEN, Örnsköldsvik (SE); Anders VESTIN, Örnsköldsvik (SE)

(73) Assignee: BAE Systems Hägglunds Aktiebolag, Örnsköldsvik (SE)

(21) Appl. No.: 18/710,838

(22) PCT Filed: Nov. 11, 2022
(86) PCT No.: PCT/SE2022/051057

§ 371 Date: May 16, 2024

(30) Foreign Application Priority Data
Dec. 20, 2021 (SE) 2151557-2

(51) Int. Cl. B62D 55/088

(52) U.S. Cl. CPC B62D 55/088; B60Y 2200/25

(57) ABSTRACT

The disclosure relates to a deflector arrangement for a tracked vehicle. Said tracked vehicle comprises a vehicle body and a left and right track assembly for supporting said vehicle body. The respective track assembly comprises two end wheel members, a plurality of road wheels there between, and an endless track disposed around said end wheel members. One of the end wheel members is a drive wheel member and the other is a tension wheel member. Said deflector arrangement is associated with an end wheel member. Said deflector arrangement comprises a deflector member being arranged and fixedly attached in connection to said inner side of an end wheel member so as to reduce ingestion of undesired material from the ground into said track assembly. The disclosure also relates to a tracked vehicle comprising at least one such deflector arrangement.

### CROSS-REFERENCE TO RELATED APPLICATIONS

This application is a U.S. national stage application under 35 U.S.C. 371 of International Application No. PCT/SE2022/051057, filed Nov. 11, 2022, which claims the priority of SE Application No. 2151557-2, filed Dec. 20, 2021. The entire contents of each priority application is incorporated herein by reference.

### FIELD OF THE DISCLOSURE

The present invention relates to a deflector arrangement for a tracked vehicle. The present invention relates to a tracked vehicle comprising a deflector arrangement.

### BACKGROUND OF THE DISCLOSURE

Tracked vehicles normally comprise a pair of track assemblies, where each track assembly of the pair of track assemblies comprises a front drive wheel, a rear tension wheel and a plurality of road wheels there between. The respective track assembly further comprises an endless track running over the drive wheel, the plurality of road wheels and the tensions wheel. Said drive wheel and said plurality of road wheels are rotatably secured to the vehicle body of the vehicle.

Such tracked vehicles, e.g. combat vehicles, are intended to be driven in rough terrain. A problem during drive in rough terrain with such vehicles is that ingestion of undesired material such as gravel and stones into the respective track assembly and in between wheels and the endless track may occur which in turn cause damages to the tracked vehicle and in some cases may result in the endless track being torn apart.

US2008150355A1 discloses a deflector for reducing the ingestion of snow and/or other debris in one of the sprocket wheel and idler wheel area of a vehicle equipped with endless tracks.

WO2020013751 discloses a deflector arrangement with a plough arrangement configured to reduce ingestion of undesired material from the ground into the track assembly, where the deflector arrangement is resiliently and biasedly arranged and coaxially suspended with respect to an axis of an end wheel of the track assembly.

There is however a need to present improvements in deflector arrangements for tracked vehicles.

### OBJECT OF THE INVENTION

An object of the present invention is to provide a deflector arrangement for a tracked vehicle, which efficiently reduces ingestion of undesired material from the ground into said track assembly and facilitates removal of such undesired material from said track assembly.

A further object of the present invention is to provide a tracked vehicle comprising such a deflector arrangement.

### SUMMARY OF THE DISCLOSURE

These and other objects, which will become apparent from the following description, are achieved by a deflector arrangement for a tracked vehicle, and a tracked vehicle as set out in the appended independent claims. Preferred embodiments of the deflector arrangement are defined in the appended dependent claims.

Specifically an object of the invention is achieved by a deflector arrangement for a tracked vehicle, said tracked vehicle comprising a vehicle body, a track assembly pair configured to support said vehicle body, said track assembly pair comprising a left track assembly and a right track assembly. The respective track assembly comprises an endless track, two end wheel members in the form of a front wheel member at a front end side of said track assembly and a rear wheel member at a rear end side of said track assembly, and further a plurality of road wheels there between. Said end wheel members has an outer side facing in the transversal direction of the vehicle away from the vehicle and an opposite inner side, when said track assembly is connected to the vehicle. At least one of the front wheel member and rear wheel member is a drive wheel member and at least one of the front wheel member and rear wheel member is a tension wheel member. Said endless track is disposed around said end wheel members and plurality of road wheels. Said deflector arrangement is associated with an end wheel member. Said deflector arrangement comprises a deflector member being arranged and fixedly attached in connection to said inner side of an end wheel member so as to reduce ingestion of undesired material from the ground into said track assembly. Thus, said deflector member is arranged and fixedly attached in connection to said inner side of an end wheel member of said rear wheel member and front wheel member of a track assembly.

According to an aspect of the present disclosure, said deflector arrangement, comprising said deflector member, is arranged and fixedly attached in connection to said inner side of an end wheel member so as to reduce ingestion of undesired material from the ground into said track assembly by means of said deflector member. According to an aspect of the present disclosure, said deflector member is arranged and fixedly attached in connection to said inner side of an end wheel member so as to enable the deflector member to remain in a stationary position relative to the end wheel member. According to an aspect of the present disclosure, said deflector member is configured to be non-rotatably arranged and fixedly attached in connection to said inner side of an end wheel member. According to an aspect of the present disclosure, said deflector member is configured to be non-resiliently arranged and fixedly attached in connection to said inner side of an end wheel member. According to an aspect of the present disclosure, said deflector member is configured to be arranged and fixedly attached in connection to said inner side of an end wheel member so that essentially no movement of said deflector member relative to said endless track is allowed, said endless track being allowed to move relative to said deflector member when said endless track is rotated, by means of said drive wheel member.

By thus providing a deflector arrangement being associated with an end wheel and comprising a deflector member being arranged and fixedly attached in connection to said inner side of said end wheel member, ingestion of undesired material from the ground such as gravel and stones into said track assembly may be reduced in a cost-efficient way. By providing such a deflector arrangement facilitating such a function of reducing ingestion of undesired material from the ground such as gravel and stones into said track assembly, reduced costs for the tracked vehicle and increased availability of the tracked vehicle is facilitated due to reduction of damages on end wheel parts such as teeth engaging with the endless track, reduction of damages on the endless track and reduction of damages on road wheels of the track assembly. Further, removal of such undesired material from said track assembly is facilitated by thus fixedly arranging such a deflector member at the inner side of said end wheel member. Thus, herby the risk of the endless track being torn apart due to undesired material from the ground being ingested into the track assembly may be efficiently avoided. Hereby an endless track of rubber material may advantageously be used. By thus providing a deflector arrangement comprising a deflector member fixedly arranged at the inner side of said end wheel member a robust arrangement with relatively low weight and no moving parts may be provided, thereby providing a cost-efficient solution facilitating low investment cost and low maintenance costs over time.

According to an embodiment of the deflector arrangement said deflector member is configured to be fixedly attached to a non-rotating portion of said end wheel member at said inner side of said end wheel member. By thus fixedly attaching said deflector member to said non-rotating portion, e.g. a hub member, of said end wheel member, said deflector member may be easily and efficiently arranged at said end side of said end wheel member for facilitating efficient reduction of ingestion of undesired material from the ground into said track assembly. According to an aspect of the present disclosure, said deflector arrangement comprises an attachment configuration for attaching said deflector member to said non-rotating portion of said end wheel member. According to an aspect of the present disclosure, said deflector member is configured to be fixedly attached to said non-rotating portion of said end wheel member at said inner side of said end wheel member so as to enable the deflector member to remain in a stationary position relative to the end wheel member.

According to an embodiment of the deflector arrangement said deflector member is configured to be fixedly attached to a body portion of said vehicle body of said vehicle in connection to said inner side. By thus fixedly attaching said deflector member to a body portion of said vehicle body, easy attachment in connection to said end wheel member without any connection to so that said deflector member may be arranged at said end side of said end wheel member for facilitating efficient reduction of ingestion of undesired material from the ground into said track assembly. According to an aspect of the present disclosure, said end wheel member, when fixedly attaching said deflector member to a portion of the vehicle body, is a drive wheel member. Said drive wheel member is attached to said vehicle body via a drive axle. Said drive wheel member is configured to essentially not provide any axial movement relative to said vehicle body, thereby facilitating to a body portion of said vehicle body of said vehicle in connection to said inner side of said drive wheel member. According to an aspect of the present disclosure, said deflector member is configured to be fixedly attached to said body portion of said vehicle body of said vehicle at said inner side of said end wheel member so as to enable the deflector member to remain in a stationary position relative to the end wheel member.

According to an embodiment of the deflector arrangement said deflector arrangement is associated with a rear wheel member of said end wheel members. By thus having said deflector arrangement associated with a rear wheel member and thus fixedly attaching said deflector member to said rear wheel member, efficient prevention of ingestion of undesired material from ground into said track assembly is facilitated. According to an aspect of the present disclosure, said rear wheel member is a tension wheel member. According to an aspect of the present disclosure, said rear wheel member is a drive wheel member.

According to an aspect of the present disclosure, a tracked vehicle being provided a deflector member of the deflector arrangement arranged and fixedly attached in connection to an inner side of a rear wheel member of the respective track assembly, may further be provided with a deflector member of a deflector arrangement arranged and fixedly attached in connection to an inner side of said front wheel member of the respective track assembly so as to further reduce ingestion of undesired material from the ground into said track assembly, hereby improving reduction of such ingestion also during reversed drive of the vehicle. Thus, this has the advantage that good ingestion prevention function will be obtained also when vehicle is driving in reverse direction, i.e. moving backwardly. This also provides advantages regarding reduction of ingestion of undesired material from the ground into said track assembly when vehicle is moving forward. This also provides advantages depending on the location of the front wheel member relative to the ground with regard to reduction of ingestion of undesired material from the ground into said track assembly. According to an aspect of the present disclosure said front wheel member is a drive wheel member and said rear wheel member is a tension wheel member. According to an alternative aspect of the present disclosure said front wheel member is a tension wheel member and said rear wheel member is a drive wheel member.

According to an aspect of the present disclosure, the respective end wheel member is rotatable about a centre axis, said centre axis having a transversal extension relative to the longitudinal extension of the vehicle, when said track assembly is connected to the vehicle. According to an embodiment of the deflector arrangement, said deflector member is configured to be arranged in connection to said inner side of said end wheel member so that said deflector member runs along a portion of said inner side of said end wheel member with an at least partly circumferential extension radially externally to the centre axis of said end wheel member in connection to an inner side of said endless track opposite to a ground engaging side of said endless track so as to facilitated said reduction of ingestion of undesired material from the ground into said track assembly. Hereby prevention of ingestion of undesired material from the ground into said end wheel, deflection of undesired material in connection to the inner side of the endless track, and prevention of ingestion of undesired material from entering the inner side of the endless track for preventing such undesired material to be dragged along by means of the rotating endless track is facilitated.

According to an aspect of the present disclosure, when said track assembly is connected to said vehicle and essentially horizontally arranged, at said inner side of said end wheel member and radially internally relative to the inner side of said endless track, there is an upper space above said centre axis, an opposite lower space below said centre axis and thereby closer to the ground, an end space between said centre axis and the end side of the track assembly at which said end wheel is arranged, and an inner space opposite to the end space relative to the centre axis of the end wheel member. According to an embodiment of the deflector arrangement, said deflector member is configured to be arranged in connection to said inner side so that said deflector member runs along at least a portion of said lower space and/or at least a portion of said end space so as to facilitate said reduction of ingestion of undesired material from the ground into said track assembly. By thus arranging said deflector member at said lower space and/or end space, prevention of ingestion of undesired material from the ground into said end wheel, deflection of undesired material in connection to the inner side of the endless track, and prevention of ingestion of undesired material from entering the inner side of the endless track for preventing such undesired material to be dragged along by means of the rotating endless track is facilitated.

According to an embodiment of the deflector arrangement, said deflector member is configured to be fixedly attached in connection to said inner side of said end wheel member so that at least a portion of said deflector member is arranged to run along said lower space. By thus arranging said deflector member at said lower space, prevention of ingestion of undesired material from the ground into said end wheel and deflection of undesired material in connection to the inner side of the endless track is facilitated.

According to an embodiment of the deflector arrangement, said deflector member is configured to be fixedly attached in connection to said inner side of said end wheel member so that at least a portion of said deflector member is arranged to run along said end space. By thus arranging said deflector member at said end space prevention of ingestion of undesired material from entering the inner side of the endless track for preventing such undesired material to be dragged along by means of the rotating endless track is facilitated.

According to an embodiment of the deflector arrangement, said deflector member comprises a first element configured to be positioned in the lower space, a second element configured to be positioned in the lower space and/or the end space, and a third element configured to be positioned in the end space, said second element being arranged between said first element and third element. Hereby prevention of ingestion of undesired material from the ground into said end wheel, deflection of undesired material in connection to the inner side of the endless track, and prevention of ingestion of undesired material from entering the inner side of the endless track for preventing such undesired material to be dragged along by means of the rotating endless track is facilitated.

According to an embodiment of the deflector arrangement, said first element is configured to be positioned so as to facilitate preventing ingestion of undesired material from the ground into said end wheel, said second element is configured to be positioned so as to provide a deflection function for facilitating deflection of undesired material in connection to the inner side of the endless track, and said third element is configured to be positioned so as to facilitate preventing ingestion of undesired material from entering the inner side of the endless track at said end space for preventing such undesired material to be dragged along by means of the rotating endless track. By providing a deflector arrangement with a deflector member having said first, second and third elements with such functions for reducing ingestion of undesired material, reduced costs for the tracked vehicle and increased availability of the tracked vehicle is facilitated due to reduction of damages on end wheel parts such as teeth engaging with the endless track, reduction of damages on the endless track and reduction of damages on road wheels of the track assembly.

According to an embodiment of the deflector arrangement, said first element has a main extension essentially corresponding to the longitudinal extension of the track assembly, said second element has a main extension inwardly away from said inner side of said end wheel member with an angle relative to the longitudinal extension of the track assembly, and said third element has a main extension essentially orthogonal to the longitudinal extension of the track assembly and essentially orthogonal to the axial direction of the centre axis. Hereby prevention of ingestion of undesired material from the ground into said end wheel is facilitated by means of said first element, deflection of undesired material in connection to the inner side of the endless track is facilitated by means of said second element providing a plough function, and prevention of ingestion of undesired material from entering the inner side of the endless track for preventing such undesired material to be dragged along by means of the rotating endless track is facilitated by means of said third element.

According to an embodiment of the deflector arrangement, said first element has a plate configuration extending along the longitudinal extension of said track assembly in a plane essentially corresponding to the rotational plane of said centre axis, said third element has a plate configuration extending, at an axial distance further away from said inner side of said end wheel member relative to said first element, in a plane essentially parallel to the plane of said first element, wherein said second element runs between said first element and third element so that deflection of undesired material from the ground is facilitated. Hereby prevention of ingestion of undesired material from the ground into said end wheel is facilitated by means of said first element, deflection of undesired material in connection to the inner side of the endless track is facilitated by means of said second element providing a plough function, and prevention of ingestion of undesired material from entering the inner side of the endless track for preventing such undesired material to be dragged along by means of the rotating endless track is facilitated by means of said third element.

According to an embodiment, the deflector arrangement further comprises an attachment configuration, wherein said deflector member is configured to be fixedly attached in connection to said inner side of said end wheel member via said attachment configuration. Hereby fixed attachment of said deflector member at said inner side of said end wheel member is facilitated. Further, the shape and configuration of the deflector member is hereby facilitated so that the shape and configuration may be optimized for prevention of ingestion and facilitation of deflection. According to an aspect of the present disclosure, said deflector member is configured to be fixedly attached to said attachment configuration, wherein said deflector member is configured to be fixedly attached in connection to said inner side of said end wheel member via said attachment configuration. According to an aspect of the present disclosure, said attachment configuration is configured to be fixedly attached in connection to said inner side of said end wheel member, wherein said deflector member is configured to be fixedly attached to said attachment configuration.

According to an aspect of the present disclosure, the invention is achieved by a track assembly comprising at least one deflector arrangement as set out herein.

Specifically, the present invention is achieved by a tracked vehicle comprising at least one deflector arrangement as set out herein.

Said tracked vehicle comprises a vehicle body, a track assembly pair configured to support said vehicle body, said track assembly pair comprising a left track assembly and a right track assembly. The respective track assembly comprises an endless track, two end wheel members in the form of a front wheel member at a front end side of said track assembly and a rear wheel member at a rear end side of said track assembly, and further a plurality of road wheels there between. Said end wheel members has an outer side facing in the transversal direction of the vehicle away from the vehicle and an opposite inner side, when said track assembly is connected to the vehicle. At least one of the front wheel member and rear wheel member is a drive wheel member and at least one of the front wheel member and rear wheel member is a tension wheel member. Said endless track is disposed around said end wheel members and plurality of road wheels. Said deflector arrangement is associated with an end wheel member. Said deflector arrangement comprises a deflector member being arranged and fixedly attached in connection to said inner side of said end wheel member so as to reduce ingestion of undesired material from the ground into said track assembly. According to an aspect of the present disclosure, said tracked vehicle comprises a deflector arrangement for the respective track assembly, said deflector member being arranged and fixedly attached in connection to said inner side of an end wheel member of the respective track assembly, said end wheel member, according to an embodiment being said rear end wheel member. According to an alternative aspect of the present disclosure, said tracked vehicle comprises a front and rear deflector arrangement for the respective track assembly, a deflector member of said front deflector arrangement being arranged and fixedly attached in connection to said inner side of said front end wheel member of the respective track assembly, and a deflector member of said rear deflector arrangement being arranged and fixedly attached in connection to said inner side of said rear end wheel member of the respective track assembly.

### BRIEF DESCRIPTION OF THE FIGURES

For a better understanding of the present disclosure reference is made to the following detailed description when read in conjunction with the accompanying drawings, wherein like reference characters refer to like parts throughout the several views, and in which:

FIG. 1 schematically illustrates a side view of a tracked vehicle according to an embodiment of the invention;

FIG. 2 schematically illustrates a perspective view of a portion of a track assembly of a tracked vehicle with a deflector arrangement according to an embodiment of the present disclosure, arranged in connection to an end wheel member of said tracked assembly;

FIG. 3 schematically illustrates a side view of the portion of the track assembly with deflector arrangement in FIG. 2;

FIG. 4 schematically illustrates a cross sectional plan view of the portion of the track assembly with deflector arrangement in FIG. 2;

FIG. 5 schematically illustrates a perspective view of the end wheel member with deflector arrangement in FIG. 2;

FIG. 6 schematically illustrates a perspective view of deflector member of a deflector arrangement according to an embodiment of the present disclosure;

FIG. 7 schematically illustrates a plan view of the tracked vehicle in FIG. 1 according to an embodiment of the present disclosure;

FIG. 8A schematically illustrates a rear view of the tracked vehicle in FIG. 1 according to an embodiment of the present disclosure;

FIG. 8B schematically illustrates a rear view of the tracked vehicle in FIG. 1 according to an alternative embodiment of the present disclosure; and,

FIG. 9 schematically illustrates a side view of a portion of a track assembly with an end wheel member, a deflector member of a deflector arrangement and schematically illustrated spaces at an inner side of said end wheel member according to an embodiment of the present disclosure.

### DETAILED DESCRIPTION OF THE DISCLOSURE

The tracked vehicle according to the present disclosure may be any suitable tracked vehicle. The tracked vehicle according to the present disclosure comprises a pair of track assembly, comprising a left track assembly arranged along the left side of the tracked vehicle and a right track assembly arranged along the right side of the tracked vehicle. The respective track assembly comprises two end wheels in the form of a front wheel and a rear wheel, and further a plurality of road wheels there between. For the tracked vehicle according to the present disclosure, at least one of the front wheel and rear wheel may be a drive wheel and at least one of the front wheel and rear wheel may be a tension wheel. For the tracked vehicle according to the present disclosure, the track assembly further comprises an endless track, said endless track being disposed around said end wheels and plurality of road wheels.

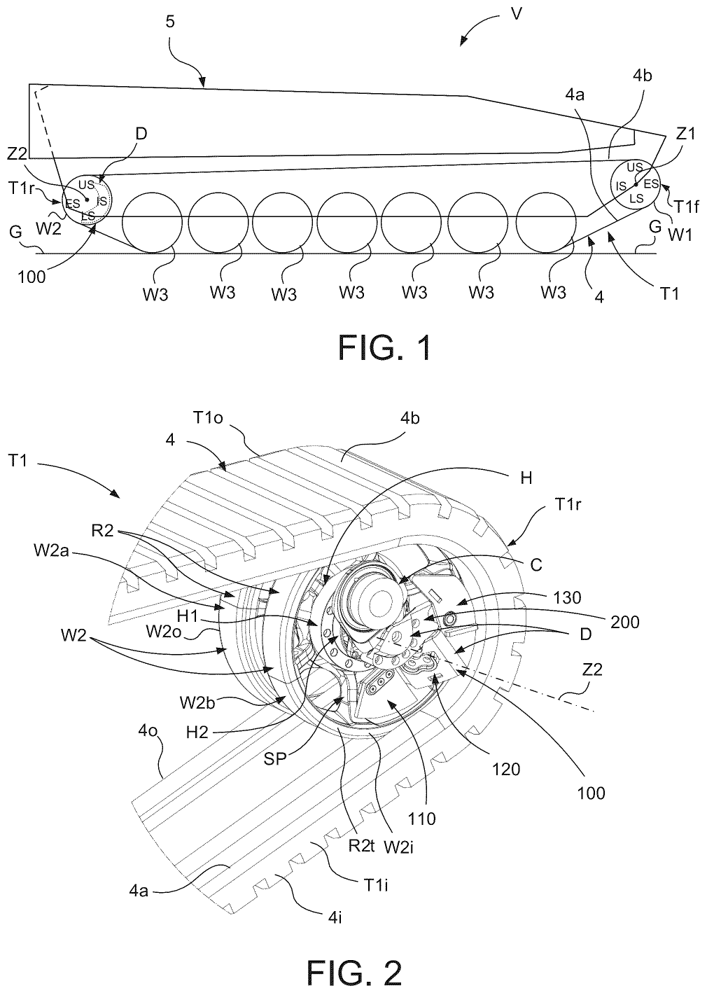

FIG. 1 schematically illustrates a side view of a tracked vehicle V according to an embodiment of the present disclosure. The tracked vehicle V is driving on a ground G. The tracked vehicle V is a motor vehicle. The exemplified tracked vehicle V is constituted by a military tracked vehicle.

The tracked vehicle V comprises a vehicle body 5, which according to an aspect of the present disclosure comprises the chassis of the vehicle V and bodywork.

The tracked vehicle V comprises a track assembly pair comprising two track assemblies, a left track assembly and a right track assembly T1, the right track assembly T1 being shown in FIG. 1. Each track assembly has a longitudinal extension and the right track assembly is configured to run in connection to the right side along the longitudinal extension of the vehicle body 5 of the vehicle V and the left track assembly is configured to run in connection to the left side along the longitudinal extension of the vehicle body 5 of the vehicle V. Each track assembly has a front end side and a rear end side, the front end side T1f and rear end side T1r of said right track assembly T1 being shown.

The respective track assembly, here illustrated with the right track assembly T1, comprises two end wheel members W1, W2 in the form of a front wheel member W1 and a rear wheel member W2, and further a plurality of road wheel members W3 there between. According to the embodiment in FIG. 1, the front wheel member W1 is a drive wheel member W1 and the rear wheel member W2 is a tension wheel member W2. The front wheel member W1, i.e. drive wheel member W1 is arranged in connection to the front end side T1f of said track assembly T1 and the rear wheel member W2, i.e. tension wheel member W2, is arranged in connection to the rear end side T1r of said track assembly T1. The tracked vehicle according to the present disclosure may however have track assemblies with any suitable arrangement of drive wheel member, tension wheel member and road wheels. According to an aspect of the present disclosure the tension wheel may be arranged in the front, the drive wheel member arranged in the back and the road wheels arranged there between. According to an aspect, the present disclosure relates to a deflector arrangement for a tracked vehicle.

The track assembly further comprises an endless track 4. Said endless track 4 is disposed around said end wheel members W1, W2 and plurality of road wheel members W3. The endless track 4 is thus configured to run around the drive wheel member W1, tension wheel member W2 and plurality of road wheel members W3. The endless track 4 is a propulsion track 4 running around said wheel members W1, W2, W3 for driving the vehicle V.

The endless track 4 of the respective track assembly is arranged to be driven and hence rotated by means of said drive wheel member W1. The tracked vehicle V comprises a drive means, not shown, for driving said drive wheel members W1. The drive means may be any suitable drive means such as an internal combustion engine and/or an electric machine. The drive wheel member W1 is thus configured to be operated by any suitable drive means such as an internal combustion engine and or/or an electric machine. The drive wheel member W1 is configured to be rotated by the drive means for rotating the endless track for driving the vehicle. The respective drive wheel of the vehicle V is configured to be rotated by the drive means.

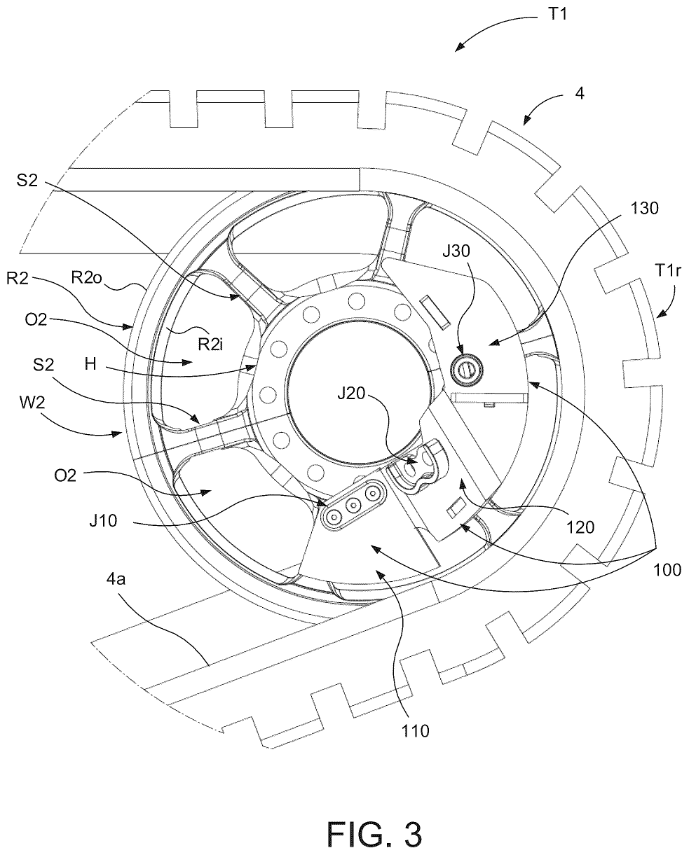

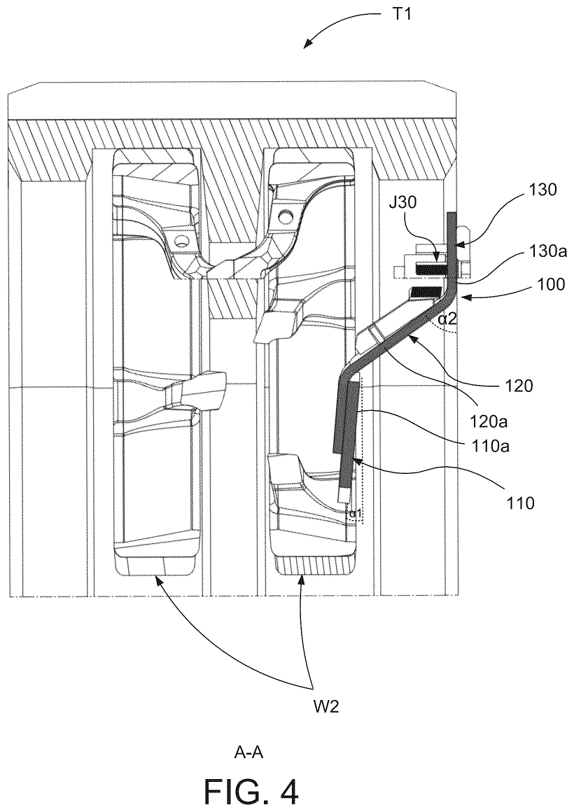

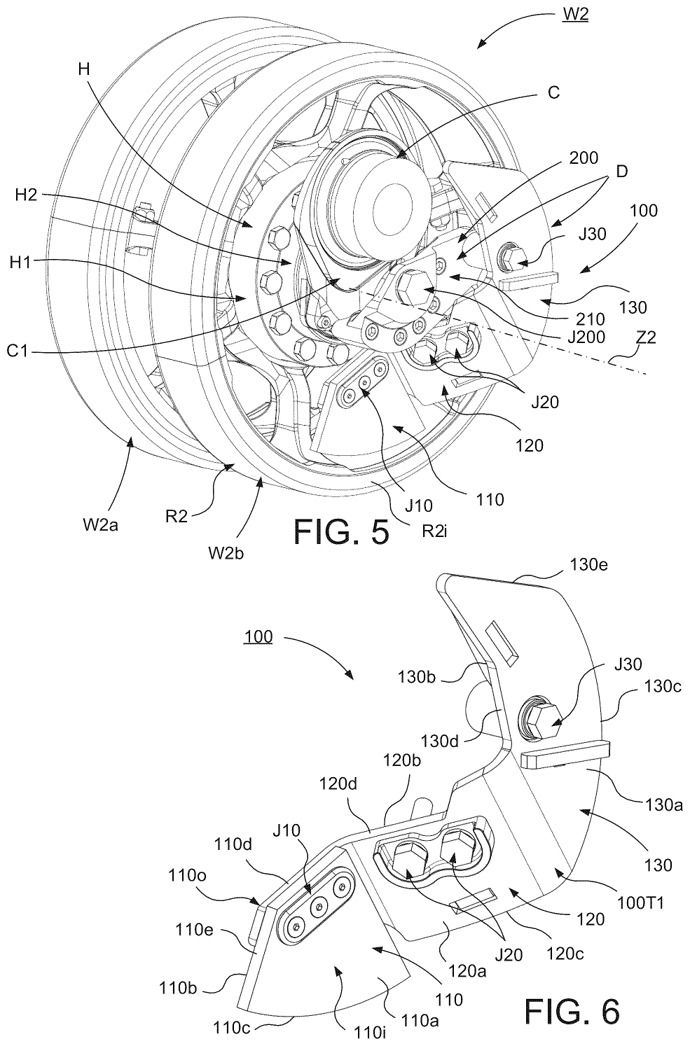

FIG. 2 schematically illustrates a perspective view of a portion of a track assembly T1 of a tracked vehicle with a deflector arrangement D according to an embodiment of the present disclosure, arranged in connection to an end wheel member W2 of said tracked assembly T1. FIG. 3 schematically illustrates a side view, FIG. 4 a cross sectional plan view of the portion of the track assembly with deflector arrangement in FIG. 2, and FIG. 5 a perspective view of the end wheel member with deflector arrangement D in FIG. 2. FIG. 6 schematically illustrates a perspective view of deflector member 100 of a deflector arrangement, e.g. the deflector arrangement D in FIG. 2, according to an embodiment of the present disclosure.

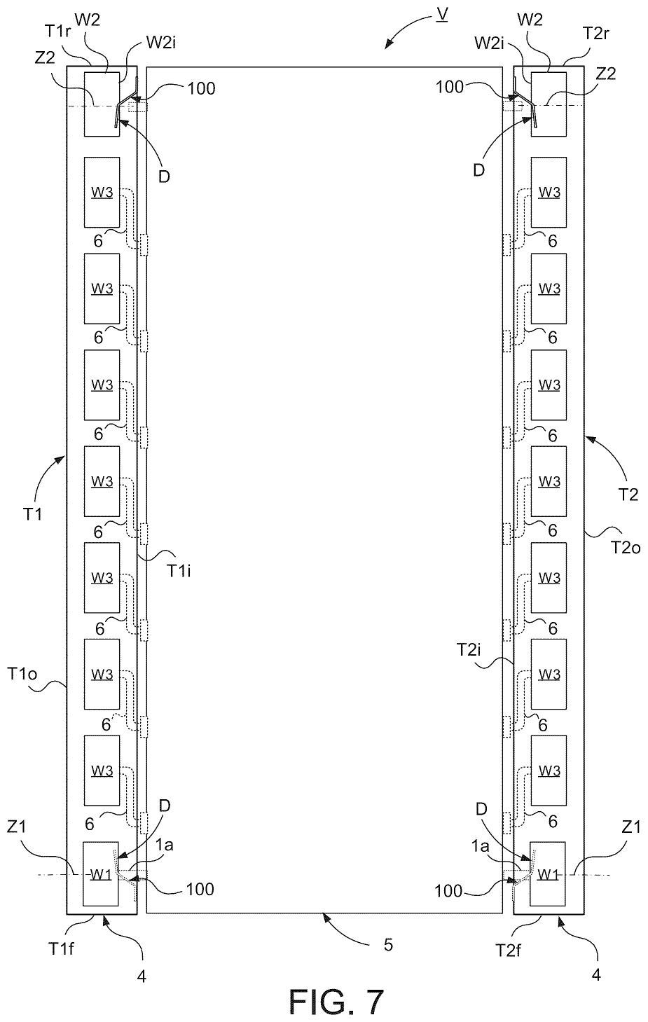

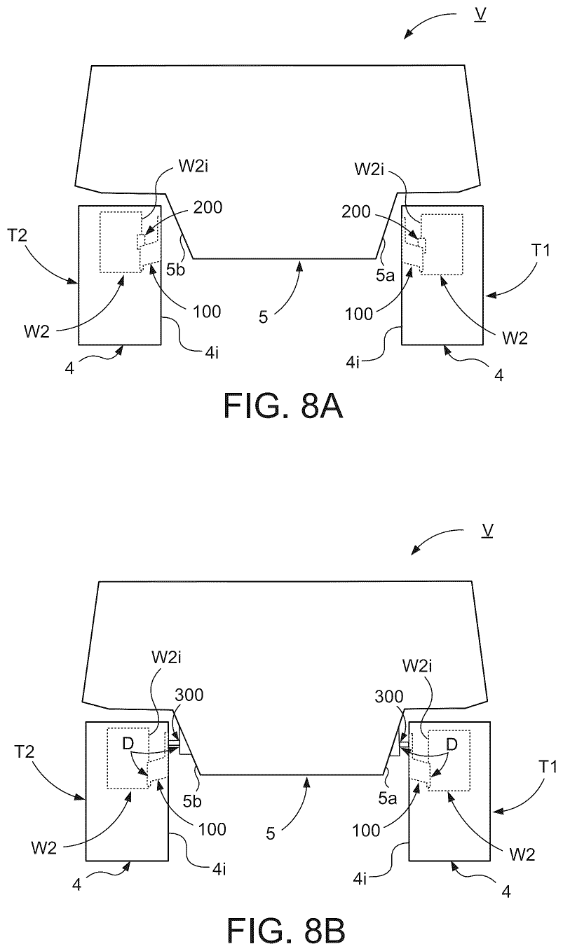

FIG. 7 schematically illustrates a plan view of the tracked vehicle V in FIG. 1 according to an embodiment of the present disclosure. FIGS. 8A and 8B schematically illustrates a rear view of the tracked vehicle in FIG. 1 according to different embodiments of the present disclosure. Said tracked vehicle V comprises a pair of track assemblies T1, T2 with a deflector arrangement with deflector member 100 associated with the respective track assembly T1, T2.

As shown in FIG. 7, the respective track assembly T1, T2 has a transversal outer side T1o, T2o configured to face away from the vehicle V and an opposite transversal inner side T1i, T2i configured to face towards the opposite track assembly of the pair of track assemblies T1, T2.

The endless track 4 of the respective track assembly T1 of the tracked vehicle V has an outer side 4o facing out from a vehicle in the transversal direction of the vehicle and an inner side 4i facing towards the vehicle in the transversal direction of the vehicle to which the track assembly is mounted, see FIG. 2. The outer side 4o facing out from a vehicle in the transversal direction of the vehicle V is thus a transversal outer side 4o. The inner side 4o facing towards the vehicle in the transversal direction of the vehicle V is thus a transversal inner side 4i. The transversal outer side 4o and transversal inner side 4i are facing in a direction corresponding to the direction of said centre axis Z2.

The endless track 4 of the respective track assembly T1 of the tracked vehicle V has an inner side 4a facing towards the tension wheel member W2 when the track 4 is engaging with the tension wheel member W2, and an opposite outer side 4b facing away from the tension wheel member W2 when the track 4 is engaging with the tension wheel member W2 and, see FIG. 2. The inner side 4a of the track 4 may be denoted radial inner side 4a and the outer side 4b may be denoted radial outer side 4b when the track 4 is engaging with the tension wheel member W2.

The outer side 4b is a ground engaging outer side 4b, a portion of said ground engaging outer side 4b being configured to engage with the ground, the portion changing during drive and thus rotation of the track 4. The inner side 4a is a wheel engaging inner side 4a, a portion of said wheel engaging inner side 4a being configured to engage with the drive wheel member W1 and another portion with the tension wheel member W2, the portion changing during drive and thus rotation of the track 4. The ground engaging outer side 4b and the opposite wheel engaging inner side 4a of the endless track 4 are thus facing in a direction orthogonal to the direction of the transversal outer side 4o and transversal inner side 4i of the endless track 4.

The endless track 4 is configured to surround wheels of the vehicle, see e.g. FIG. 1, including said end wheel member W2, here tension wheel member W2, so that the portion of said inner side 4a engaging with said wheels is facing said wheels.

Further the vehicle 1 comprises a vehicle body 5, which may include the chassis of the vehicle and bodywork.

The vehicle V comprises a suspension system comprising a suspension device for the respective track assembly. The respective track assembly of the vehicle V is thus arranged to be supported by the vehicle body 5 by means of said suspension device. The road wheel members W3 of the respective track assembly of the vehicle V is arranged to be supported by the vehicle body 5 by means of said suspension device. Hereby movability and comfort of the vehicle V is improved in that the vehicle body 5 is allowed to be raised and lowered relative to the track assembly. An embodiment of such a suspension device is described in more detail with reference to FIG. 7.

According to an aspect of the present disclosure, illustrated in FIG. 2, said tension wheel member W2 comprises an outer wheel W2o facing out from a vehicle in the transversal direction of the vehicle and an inner wheel W2i facing towards the opposite track assembly in the transversal direction of the vehicle to which the track assembly is mounted.

According to an aspect of the present disclosure, said end wheel member comprises a ring shaped outer member having a radial outer side configured to engage with said inner side 4a of said endless track 4 and an opposite radial inner side facing towards said centre axis of said end wheel member.

According to an aspect of the present disclosure, as illustrated in e.g. FIG. 2 and FIG. 5, said tension wheel member W2 comprises a ring shaped outer member R2 having a radial outer side R2o configured to engage with said inner side 4a of said endless track 4 and an opposite radial inner side R2i facing towards said centre axis Z2 of said tension wheel member W2. Said ring shaped outer member R2 has a transversal inner side R2t facing towards the opposite track assembly in the transversal direction of the vehicle to which the track assembly is mounted. Said transversal inner side R2t is thus part of said inner side W2i of said end wheel member W2. Said ring shaped outer member R2 is thus configured to rotate with said endless track 4 during drive of said tracked vehicle.

According to an aspect of the present disclosure, said end wheel member comprises a hub member H coaxially arranged relative to said centre axis of the end wheel member. Said hub member H is configured to be connected to said vehicle body 5 of said tracked vehicle V so as to facilitate rotation of said tension wheel member TW relative to said vehicle body 5.

According to an aspect of the present disclosure, as illustrated in e.g. FIG. 2 and FIG. 5, said tension wheel member W2 comprises a hub member H coaxially arranged relative to said centre axis Z2. Said hub member H is connected to said vehicle body 5 of said tracked vehicle V so as to facilitate rotation of said tension wheel member W2 relative to said vehicle body 5.

According to an aspect of the present disclosure, said hub member H is journaled in bearings so as to facilitate allowing said rotation of said end wheel member, here tension wheel member W2, relative to said vehicle body 5. According to an aspect of the present disclosure, said hub member H comprises a rotating portion H1 configured to rotate relative to said vehicle body 5 by means of rotation of said endless track 4. According to an aspect of the present disclosure, said hub member H comprises a non-rotating portion H2 configured to be fixed relative to the rotating portion and thus relative to the rotation of said endless track 4.

According to an aspect of the present disclosure, said end wheel member comprises radially running spokes arranged between and distributed around said hub member H and ring shaped outer member so that openings are obtained there between. According to an aspect of the present disclosure, said radially running spokes are at one end attached in connection to said radial inner side of said ring shaped outer member and at an opposite end attached in connection to the rotating portion H1 of said hub member H.

According to an aspect of the present disclosure, as illustrated in e.g. FIG. 2 and FIG. 5, said tension wheel member W2 comprises radially running spokes S2 arranged between and distributed around said hub member H and ring shaped outer member R2 so that openings O2 are obtained there between. According to an aspect of the present disclosure, said radially running spokes S2 are at one end attached in connection to said radial inner side R2i of said ring shaped outer member R2 and at an opposite end attached in connection to the rotating portion H1 of said hub member H.

According to an aspect of the present disclosure, said tension wheel member TW comprises a crankshaft C, see FIGS. 2 and 5. Said crankshaft C is configured to be arranged in connection to the inner side of said hub member H. Said crankshaft C is configured to be connected to the hub member H and arranged in connection to the inner wheel W2i. Said crankshaft C is configured to project from the inner side of said hub member H and from the transversal inner side 4i of the endless track 4.

According to an aspect of the present disclosure, said crankshaft C comprises an outer lever C1 arranged closest to said hub member H. According to an aspect of the present disclosure, said outer lever is configured to be attached to said hub member H at a fastening point in connection to said an end portion so as to allow rotation of said outer lever C1 about said centre axis Z2. Said crankshaft C is only partly shown in FIGS. 2 and 5 and is not described in any more detail here.

FIG. 2 thus shows a portion of the right track assembly T1. The track assembly T1 has a transversal outer side T1o configured to face away from the vehicle and an opposite transversal inner side T1i configured to face towards the opposite track assembly of the pair of track assemblies, see FIG. 7. FIG. 2 schematically illustrates a perspective view of a portion of the track assembly T1 showing the inner side T1i of the track assembly, i.e. the side of the track assembly facing inwardly towards the opposite track assembly, not shown in FIG. 2. Thus, the inner side W2i of the tension wheel member W2 is shown in FIG. 2.

The tracked vehicle V comprises a deflector arrangement D for the respective track assembly T1, T2. The deflector arrangement D is configured to reduce ingestion of undesired material from the ground G into the respective track assembly T1, T2 of said tracked vehicle V.

Said deflector arrangement D is associated with an end wheel member W1, W2. According to the embodiment illustrated in e.g. FIGS. 1-4, 7 and 8A-8B, said deflector arrangement D is associated with the rear wheel member W2. According to the embodiment illustrated in e.g. FIGS. 1-4, 7 and 8A, said deflector arrangement D is associated with the tension wheel member W2 arranged at the rear end side T1r, see e.g. FIG. 1, of said track assembly of said tracked vehicle V. According to the embodiment illustrated in FIG. 8B, said deflector arrangement D is associated with the rear wheel member W2 being a drive wheel member W2 arranged at the rear end side of said track assembly of said tracked vehicle V.

Said deflector arrangement D comprises a deflector member 100. Said deflector member 100 is configured to be arranged and fixedly attached in connection to said inner side W2i of said end wheel member W1, W2 so as to reduce ingestion of undesired material from the ground G into said track assembly T1, T2.

According to an aspect of the present disclosure, said deflector arrangement D, comprising said deflector member 100, is arranged and fixedly attached in connection to said inner side W2i of an end wheel member W1, W2 so as to reduce ingestion of undesired material from the ground G into said track assembly by means of said deflector member 100.

According to an aspect of the present disclosure, said deflector member 100 is arranged and fixedly attached in connection to said inner side W2i of an end wheel member W1, W2 so as to enable the deflector member 100 to remain in a stationary position relative to the end wheel member. For example, said deflector member 100 is arranged and fixedly attached in connection to said inner side W2i of an end wheel member W1, W2 such that the deflector member 100 remains in a stationary position relative to the end wheel member when said end wheel member rotates.

According to an aspect of the present disclosure, said deflector arrangement D, comprising said deflector member 100 is arranged and fixedly attached in connection to said inner side W2i of an end wheel member W1, W2 so as to enable said deflector arrangement D, comprising the deflector member 100 to remain in a stationary position relative to the end wheel member. For example, said deflector arrangement D is arranged and fixedly attached in connection to said inner side W2i of an end wheel member W1, W2 such that the deflector arrangement D remains in a stationary position relative to the end wheel member when said end wheel member rotates.

According to an aspect of the present disclosure, said deflector member 100 is configured to be non-rotatably arranged and fixedly attached in connection to said inner side W2i of an end wheel member W1, W2.

According to an aspect of the present disclosure, said deflector member 100 is configured to be non-resiliently arranged and fixedly attached in connection to said inner side W2i of an end wheel member.

According to an aspect of the present disclosure, said deflector member 100 is configured to be arranged and fixedly attached in connection to said inner side W2i of an end wheel member W1, W2 so that essentially no movement of said deflector member 100 relative to said endless track 4 is allowed, said endless track 4 being allowed to move relative to said deflector member 100 when said endless track 4 is rotated, by means of said drive wheel member W1.

According to the embodiment illustrated in e.g. FIGS. 1-4, 7 and 8A, said deflector member 100 is configured to be arranged and fixedly attached in connection to said inner side W2i of said tension wheel member W2 arranged at the rear end side of said track assembly of said tracked vehicle V.

According to an aspect of the present disclosure, as illustrated e.g. in FIGS. 2, 5 and 8A, said deflector member 100 is configured to be fixedly attached to a non-rotating portion of said end wheel member W2, here tension wheel member W2, at said inner side W2i of said end wheel member. According to an aspect of the present disclosure, said non-rotating portion of said tensions wheel member W2 is said non-rotating portion H2 of said hub member H of said tension wheel member W2. According to an aspect of the present disclosure, said deflector member 100 is configured to be fixedly attached to said non-rotating portion H2 of said hub member H.

According to an aspect of the present disclosure, said deflector arrangement D comprises an attachment configuration 200; 300. Attachment configuration 200 is schematically illustrated in e.g. FIGS. 2, 5 and 8A, and attachment configuration 300 is schematically illustrated in FIG. 8B. Said attachment configuration 200; 300 is configured to facilitate fixedly attaching said deflector member 100 at said transversal inner side W2i of said end wheel member W2. According to an aspect of the present disclosure, said deflector member 100 is configured to be fixedly attached in connection to said inner side W2i of said end wheel member W2 via said attachment configuration 200; 300.

According to the embodiment illustrated in e.g. FIGS. 2 and 5, said attachment configuration 200 is configured to facilitate fixedly attaching said deflector member 100 to said non-rotating portion H2 of said hub member H at said transversal inner side W2i of said tension wheel member W2. According to an aspect of the present disclosure illustrated in e.g. FIGS. 2 and 5, said deflector arrangement D, comprising said deflector member 100 and attachment configuration 200, is arranged and fixedly attached to said non-rotating portion H2 of said hub member H at said transversal inner side W2i of said tension wheel member W2.

According to the embodiment illustrated in FIG. 5, said attachment configuration 200 comprises an attachment plate member 210 configured to be arranged at said inner side W2i and configured to be attached to said non-rotating portion H2 of said hub member H.

According to the embodiment illustrated in FIG. 5, said attachment configuration 200 comprises a joint member J200 by means of which said plate member 210 is configured to fixedly attached to said non-rotating portion H2. Said joint member J200 comprises, according to an aspect, a screw joint.

According to the embodiment illustrated in FIG. 5, said deflector arrangement D comprises joint members J20, J30 by means of which said deflection member 100 is configured to fixedly attached to said plate member 210 of said attachment configuration 200. Said joint members J20, J30 comprises, according to an aspect, screw joints.

According to an alternative aspect of the present disclosure, schematically illustrated in FIG. 8B, said rear wheel member W2 is a drive wheel member, wherein the deflector member 100 may be configured to be fixedly attached to a body portion 5a, 5b of said vehicle body 5 of said vehicle V in connection to the inner side of the drive wheel member. Said body portion is according to an embodiment a body portion 5a, 5b of said vehicle body 5, were said body portion 5a, 5b is configured to be arranged at, and at least partly face, said inner side of said end wheel member W2, here drive wheel member of the respective track assembly T1, T2, see FIG. 8B.

For the embodiment with the deflector member 100 fixedly attached to a body portion of said vehicle body 5, an attachment configuration 300 according to the present disclosure may be configured to facilitate fixedly attaching said deflector member 100 to said body portion 5a, 5b of said vehicle body 5 at said transversal inner side W2i of said drive wheel member W2.

According to an aspect of the present disclosure illustrated in FIG. 8B, said deflector arrangement D, comprising said deflector member 100 and attachment configuration 300, is arranged and fixedly attached to said non-rotating portion H2 of said hub member H at said transversal inner side W2i of said drive wheel member W2.

According to an aspect of the present disclosure, said deflector member 100 is configured to be arranged in connection to said inner side W2i so that said deflector member 100 runs along a portion of said inner side W2i of said end wheel member W1, W2 with an at least partly circumferential extension radially externally to the centre axis Z1, Z2 of said end wheel member W1, W2 in connection to said inner side 4a of said endless track 4 so as to facilitated said reduction of ingestion of undesired material from the ground G into said track assembly T1, T2.

According to the embodiment illustrated in e.g. in FIGS. 2, 3 and 5, said deflector member 100 is configured to be arranged in connection to said inner side W2i so that said deflector member 100 runs along a portion of said inner side W2i of said tension wheel member W1 with an at least partly circumferential extension radially externally to the centre axis Z2 of said tension wheel member W2 in connection to said inner side 4a of said endless track 4 so as to facilitated said reduction of ingestion of undesired material from the ground G into said track assembly T1, see FIGS. 2 and 3.

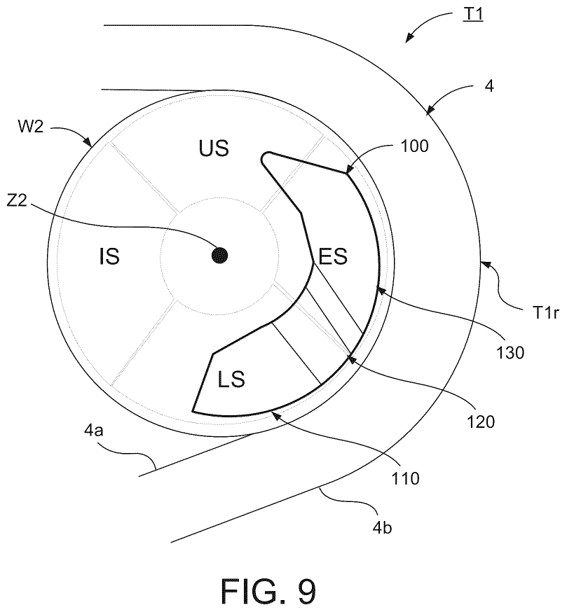

FIG. 9 schematically illustrates a side view of a portion of a track assembly T1 with an end wheel member W2 at the rear end side T1r of said track assembly, and a deflector member 100 of a deflector arrangement D arranged at said inner side W2i of said end wheel member W, according to the present disclosure. In FIG. 9 spaces US, LS, IS and ES, at said inner side W2i of said end wheel member W2 according to an embodiment of the present disclosure are schematically illustrated.

Said spaces US, LS, IS and ES are schematically illustrated in order to facilitate describing the orientation and location of said deflection member 100 at said inner side W2i of said end wheel member W2.

The location of said spaces US, LS, IS and ES are referred to when said track assembly T1 comprising said end wheel member W2 is connected to said vehicle and essentially horizontally arranged, see FIG. 1, where said spaces also are schematically illustrated.

According to an aspect of the present disclosure, said spaces US, LS, IS, ES has a transversal extension between said inner side W2i and said transversal inner side 4i of said endless track 4.

According to an aspect of the present disclosure, said spaces US, LS, IS, ES has a radial extension between said inner side 4a of said endless track and said centre axis Z2 of said end wheel member W2.

According to an aspect of the present disclosure, said spaces US, LS, IS, ES are arranged at said inner side W2i, radially internally relative to the inner side 4a of said endless track 4.

According to an aspect of the present disclosure, said spaces US, LS, IS, ES comprise an upper space US above said centre axis Z1, Z2 and an opposite lower space LS below said centre axis Z2 and thereby closer to the ground G, see also FIG. 1.

According to an aspect of the present disclosure, said spaces US, LS, IS, ES comprise an end space ES between the said centre axis Z1, Z2 and the end side, here rear end side T1r, of the track assembly T1 at which said end wheel member W2 is arranged, and an inner space IS opposite to the end space ES relative to the centre axis Z2 of the end wheel member W2.

According to an aspect of the present disclosure, as illustrated in FIG. 1 and FIG. 9, said deflector member 100 is configured to be arranged in connection to said inner side W2i so that said deflector member 100 runs along at least a portion of said lower space LS and at least a portion of said end space ES so as to facilitate said reduction of ingestion of undesired material from the ground G into said track assembly T1.

According to an aspect of the present disclosure, as illustrated in FIG. 9, said deflector member 100 is configured to be fixedly attached in connection to said inner side W2i so that at least a portion 110 of said deflector member 100 is arranged to run along said lower space LS.

According to an aspect of the present disclosure, as illustrated in FIG. 9, said deflector member 100 is configured to be fixedly attached in connection to said inner side W2i so that at least a portion of said deflector member 100 is arranged to run along said end space ES.

According to an aspect of the present disclosure, as illustrated in e.g. in FIGS. 2, 3, 4, 5, 6 said deflector member 100 comprises a first element 110, a second element 120, and a third element 130, said second element 120 being arranged between said first element 110 and third element 130.

According to an aspect of the present disclosure, as illustrated in FIG. 9, said first element 110 is configured to be positioned in the lower space LS. According to an aspect of the present disclosure, as illustrated in FIG. 9, said second element 120 configured to be positioned in the lower space LS and the end space ES. According to an aspect of the present disclosure, as illustrated in FIG. 9, said a third element 130 configured to be positioned in the end space ES. According to an aspect of the present disclosure, as illustrated in FIG. 9, a portion of said third element 130 is projecting into said upper space US. Said second element 120 is arranged between said first element 110 and third element 130.

According to an aspect of the present disclosure, said first element 110 is configured to be positioned so as to facilitate preventing ingestion of undesired material from the ground G into said end wheel member, here tension wheel member W2. According to an aspect of the present disclosure, said first element 110 has a main extension essentially corresponding to the longitudinal extension of the track assembly. According to an aspect of the present disclosure, said first element 110 has a plate configuration extending along the longitudinal extension of said track assembly in a plane essentially corresponding to the rotational plane of said centre axis Z2. According to an aspect of the present disclosure, said first element 110 has a main extension inwardly away from said inner side W2i with a relatively small angle α1, e.g. less than ten degrees, relative to the longitudinal extension of the track assembly. By thus having such an angle of said first element, a certain deflection function is provided. According to an aspect of the present disclosure, said first element 110 has a main extension inwardly away from said inner side W2i, starting from a position inside of said transversal inner side R2t and at a distance from said radial inner side R2i of said ring shaped outer member R2 in a direction towards an end side T1r of said track assembly. By thus having said first element 110 arranged in this way, starting internally relative to said transversal inner side R2t, there is no risk of said deflection member connecting with any object or the like externally relative to said transversal inner side R2i of said outer member R2 and hence end wheel member W2.

According to an aspect of the present disclosure, as illustrated in FIG. 6, said first element 110 has an inner side 110i configured to face away from said transversal inner side W2i of said tension wheel member W2 and an opposite outer side 110o configured to face towards said inner side W2i. Said inner side 110i of said first element 110 has a surface 110a, said inner side 110i being configured to facilitate providing said prevention of ingestion of undesired material from the ground G into said tension wheel member W2 by providing a protecting wall.

According to an aspect of the present disclosure, as illustrated in FIG. 6, said first element 110 has a lower edge portion 110c configured to downwardly, here radially downwardly, in connection to said radial inner side R2i of said ring shaped outer member R2. According to an aspect of the present disclosure, said lower edge portion 110c is configured to run along a lower portion of said radial inner side R2i, and thus having an arc shaped extension.

According to an aspect of the present disclosure, as illustrated in FIG. 6, said first element 110 has an upper edge portion 110d essentially opposite to said lower edge portion 110c, and an end side portion 110e configured to face away from the end side T1r of said track assembly T1.

According to an aspect of the present disclosure, said second element 120 is configured to be positioned so as to provide a deflection function for facilitating deflection of undesired material in connection to the inner side 4a of the endless track 4. According to an aspect of the present disclosure, said second element 120 has a main extension inwardly away from said inner side with an angle α2 relative to the longitudinal extension of the track assembly. Said angle α2 is according to an aspect of the present disclosure in the range from 10 to 70 degrees. Said angle α2 is according to an aspect of the present disclosure in the range from 20 to 60 degrees. Said angle α2 is according to an aspect of the present disclosure in the range from 25 to 50 degrees.

According to an aspect of the present disclosure, as illustrated in FIG. 6, said second element 120 has first surface 120a configured to face, with said angle, away from said transversal inner side W2i of said tension wheel member W2 and an opposite second surface configured to face, with said angle, towards said inner side W2i. Said first surface of said second element 120 configured to facilitate providing deflection function for facilitating deflection of undesired material in connection to the inner side 4a of the endless track 4 in that said second element 120 acts as a plough.

According to an aspect of the present disclosure, as illustrated in FIG. 6, said second element 120 has a lower edge portion 120c configured to face, here with a certain angle, downwardly towards said inner side 4a of said endless track 4.

According to an aspect of the present disclosure, as illustrated in FIG. 6, said second element 120 has an upper edge portion 120d essentially opposite to said lower edge portion 120c.

According to an aspect of the present disclosure, said third element 130 is configured to be positioned so as to facilitate preventing ingestion of undesired material from entering the inner side 4a of the endless track 4 at said end space ES for preventing such undesired material to be dragged along by means of the rotating endless track 4. According to an aspect of the present disclosure, said third element 130 has a main extension essentially orthogonal to the longitudinal extension of the track assembly and essentially orthogonal to the axial direction of the centre axis Z2.

According to an aspect of the present disclosure, said third element 130 has a plate configuration extending, at an axial distance further away from said inner side W2i of said end wheel member relative to said first element 110, in a plane essentially parallel to the plane of said first element 110.

According to an aspect of the present disclosure, as illustrated in FIG. 6, said third element 130 has an inner surface 130a configured to face away from said transversal inner side W2i of said tension wheel member W2 and an opposite outer surface 130b configured to face towards said inner side W2i. Said inner surface of said third element 130 is configured to facilitate providing said prevention of undesired material being dragged along by means of the rotating endless track 4.

According to an aspect of the present disclosure, as illustrated in FIG. 6, said third element 130 has a first end edge portion 130c configured to face in the direction of the end side T1r of said track assembly T1 and an essentially opposite second end edge portion 130d configured to face away from said end side T1r of said track assembly T1.

According to an aspect of the present disclosure, said first end edge portion 130c is configured to run, at the transversal inner side 4i of said endless track 4, along the inner side 4a of said endless track 4 at said end side T1r of said track assembly T1. According to an aspect of the present disclosure, said first end edge portion 130c is configured to run along said inner side 4a at said end side, and thus having an arc shaped extension, see e.g. FIG. 3.

According to an aspect of the present disclosure, as illustrated in FIG. 6, said third element 130 has an upper edge portion 130e facing upwardly away from the ground.

According to an aspect of the present disclosure, as illustrated in FIGS. 2-6, said first element 110 is comprises a separate element 110i configured to be attached to a portion 110o of said first element 110 being an extension of said second element 120. Said separate element of said first element 110 is configured to be attached to said portion of said first element 110 being an extension of said second element 120 by means of a joint member J10, e.g. screw joints. According to an aspect as illustrated in FIGS. 2-6, said separate element 110i is the inner most element part of said first element 110.

FIG. 7 schematically illustrates a plan view and FIGS. 8A and 8B a rear view of the tracked vehicle V in FIG. 1.

Here the right track assembly T1 and the left track assembly T2 of the tracked vehicle V are shown.

The drive wheel members W1 are operably connected to a drive axle 1a, see FIG. 7.

As mentioned above the tracked vehicle V comprises a suspension system comprising a suspension device for the respective track assembly T1, T2. The respective track assembly T1, T2 of the vehicle V is thus arranged to be supported by the vehicle body 5 by means of said suspension device.

The respective suspension device of the suspension system of the vehicle comprises according to this embodiment suspension arms 6 which may be denoted rocker arms or pendulum arms. The suspension arms 6 are in one end configured to be rotatably attached to the vehicle body 5 and in the opposite end configured to be rotatably attached to a respective road wheel 3. Said suspension arms 6 are configured such that forces acting on said plurality of road wheel members W3 cause resilient oscillation of said suspension arms 6.

The road wheel members W3 of the respective track assembly of the vehicle V are thus arranged to be supported by the vehicle body 5 by means of said suspension arms 6 of the respective suspension device.

Said track assemblies T1, T2 are thus suspendedly arranged to said vehicle body 5 via said road wheel members W3 by means of the suspension system.

The vehicle V described with reference to FIGS. 1, 7 and 8A-8B is a tracked vehicle with a left and right track assembly T1, T2 and a vehicle body 5 to which the track assemblies are suspended attached. As illustrated in FIG. 7, each track assembly T1, T2 has a front wheel member in the form of a drive wheel member W1 arranged at the front end side T1f, T2f of the respective track assembly T1, T2, and a rear wheel member in the form of a tension wheel member W2 arranged at the rear end side T1r, T2r of the respective track assembly, and a plurality of road wheel members W3 there between. Each track assembly T1, T2 comprises an endless track 4 disposed around the wheel members W1, W2, W3.

As illustrated in FIG. 7, the respective track assembly T1, T2 has a transversal outer side T1o, T2o configured to face away from the vehicle V and an opposite transversal inner side T1i, T2i configured to face towards the opposite track assembly of the pair of track assemblies T1, T2.

As illustrated in FIG. 7, a deflector member 100 of a deflector arrangement is arranged and fixedly attached in connection to an inner side W2i of said tension wheel member W2 of the respective track assembly T1, T2 so as to reduce ingestion of undesired material from the ground into said track assembly T1, T2.

According to an aspect of the present disclosure, said deflector member 100 is configured to be fixedly attached to a non rotating portion of said tension wheel member at said inner side W2i of said tension wheel member W2.

According to an aspect of the present disclosure, as schematically illustrated in FIG. 7, could, in addition to the deflector member 100 of the deflector arrangement D arranged and fixedly attached in connection to an inner side of said tension wheel member W2 of the respective track assembly T1, T2, have a deflector member 100 of a deflector arrangement D arranged and fixedly attached in connection to an inner side of said drive wheel member W1 of the respective track assembly T1, T2 so as to reduce ingestion of undesired material from the ground into said track assembly T1, T2, e.g. during reversed drive of the vehicle V.

Alternatively, a tracked vehicle similar to the tracked vehicle illustrated in FIG. 7, could have the drive wheel members W1 arranged at the rear end side T1r, T2r of the respective track assembly T1, T2, and the tension wheel members W2 arranged at the front end side of the respective track assembly, and the plurality of road wheel members W3 there between, with the endless track 4 of the respective track assembly disposed around the wheel members W1, W2, W3. For such a tracked vehicle, a deflector member 100 of a deflector arrangement may, according to an aspect of the present disclosure, be arranged and fixedly attached in connection to an inner side of said drive wheel member W1 of the respective track assembly T1, T2 so as to reduce ingestion of undesired material from the ground into said track assembly T1, T2. According to an alternative aspect of the present disclosure, with the drive wheel members W1 arranged at the rear end side T1r, T2r of the respective track assembly T1, T2, said deflector member 100 may be configured to be fixedly attached to a body portion of said vehicle body 5 of said vehicle V in connection to said inner side W2i of said tension wheel member W2.

The foregoing description of the preferred embodiments of the invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated.

1. A deflector arrangement for a tracked vehicle, said tracked vehicle comprising a vehicle body, a track assembly pair configured to support said vehicle body, said track assembly pair comprising a left track assembly and a right track assembly, the respective track assembly comprising an endless track, two end wheel members in the form of a front wheel member at a front end side of said track assembly and a rear wheel member at a rear end side of said track assembly, and further a plurality of road wheels there between, said end wheel members having an outer side facing in the transversal direction of the vehicle away from the vehicle and an opposite inner side, when said track assembly is connected to the vehicle, at least one of the front wheel member and rear wheel member being a drive wheel member and at least one of the front wheel member and rear wheel member being a tension wheel member, said endless track being disposed around said end wheel members and plurality of road wheels, said deflector arrangement being associated with an end wheel member, said deflector arrangement comprising a deflector member being arranged and fixedly attached in connection to said inner side of an end wheel member so as to reduce ingestion of undesired material from the ground into said track assembly.

2. The deflector arrangement of claim 1, wherein said deflector member is configured to be fixedly attached to a non rotating portion of said end wheel member at said inner side of said end wheel member.

3. The deflector arrangement of claim 1, wherein said deflector member is configured to be fixedly attached to a body portion of said vehicle body of said vehicle in connection to said inner side.

4. The deflector arrangement of claim 1, wherein said deflector arrangement is associated with a rear wheel member of said end wheel members.

5. The deflector arrangement of claim 1, wherein the respective end wheel member is rotatable about a centre axis, said centre axis having a transversal extension relative to the longitudinal extension of the vehicle, when said track assembly is connected to the vehicle, wherein said deflector member is configured to be arranged in connection to said inner side so that said deflector member runs along a portion of said inner side of said end wheel member with an at least partly circumferential extension radially externally to the centre axis of said end wheel member in connection to an inner side of said endless track opposite to a ground engaging side of said endless track so as to facilitated said reduction of ingestion of undesired material from the ground into said track assembly.

6. The deflector arrangement of claim 5, wherein, when said track assembly is connected to said vehicle and essentially horizontally arranged, at said inner side of said end wheel member and, in relation to said centre axis, radially internally relative to the inner side of said endless track, there is an upper space above said centre axis, an opposite lower space below said centre axis and thereby closer to the ground, an end space between the said centre axis and the end side of the track assembly at which said end wheel is arranged, and an inner space opposite to the end space relative to the centre axis of the end wheel member, wherein said deflector member is configured to be arranged in connection to said inner side of said end wheel member so that said deflector member runs along at least a portion of said lower space and/or at least a portion of said end space so as to facilitate said reduction of ingestion of undesired material from the ground into said track assembly.

7. The deflector arrangement of claim 6, wherein said deflector member is configured to be fixedly attached in connection to said inner side of said end wheel member so that at least a portion of said deflector member is arranged to run along said lower space.

8. The deflector arrangement of claim 7, wherein said deflector member is configured to be fixedly attached in connection to said inner side so that at least a portion of said deflector member is arranged to run along said end space.

9. The deflector arrangement of claim 8, wherein said deflector member comprises a first element configured to be positioned in the lower space, a second element configured to be positioned in the lower space and/or the end space, and a third element configured to be positioned in the end space, said second element being arranged between said first element and third element.

10. The deflector arrangement of claim 9, wherein said first element is configured to be positioned so as to facilitate preventing ingestion of undesired material from the ground into said end wheel, said second element is configured to be positioned so as to provide a deflection function for facilitating deflection of undesired material in connection to the inner side of the endless track, and said third element is configured to be positioned so as to facilitate preventing ingestion of undesired material from entering the inner side of the endless track at said end space for preventing such undesired material to be dragged along by means of the rotating endless track.

11. The deflector arrangement claim 10, wherein said first element has a main extension essentially corresponding to the longitudinal extension of the track assembly, said second element has a main extension inwardly away from said inner side of said end wheel member with an angle relative to the longitudinal extension of the track assembly, and said third element has a main extension essentially orthogonal to the longitudinal extension of the track assembly and essentially orthogonal to the axial direction of the centre axis.

12. The deflector arrangement of claim 11, wherein said first element has a plate configuration extending along the longitudinal extension of said track assembly in a plane essentially corresponding to the rotational plane of said centre axis, said third element has a plate configuration extending, at an axial distance further away from said inner side of said end wheel member relative to said first element, in a plane essentially parallel to the plane of said first element, wherein said second element runs between said first element and third element so that deflection of undesired material from the ground is facilitated.

13. The deflector arrangement of claim 1, further comprising an attachment configuration, wherein said deflector member is configured to be fixedly attached in connection to said inner side of said end wheel member via said attachment configuration.

14. A tracked vehicle comprising at least one deflector arrangement of claim 1.
